(19) United States
(12) Patent Application Publication
(10) Pub. No.: US 2022/0212283 A1
(43) Pub. Date: Jul. 7, 2022

(54) ADJUSTMENT METHOD OF LASER LIGHT PATH AND ADJUSTMENT DEVICE OF LASER LIGHT PATH

(71) Applicant: Industrial Technology Research Institute, Hsinchu (TW)

(72) Inventors: FU-LUNG CHOU, Tainan City (TW); PIN-HAO HU, Kaohsiung City (TW); HUI-TA CHENG, Tainan City (TW); CHING-NAN KUO, Tainan City (TW)

(21) Appl. No.: 17/477,008

(22) Filed: Sep. 16, 2021

(30) Foreign Application Priority Data
Jan. 4, 2021 (TW) 110100014

(51) Int. Cl. B23K 26/046; B23K 26/70; B23K 26/064; B23K 26/067; G02F 1/29

(52) U.S. Cl. CPC B23K 26/046; B23K 26/705; B23K 2103/54; B23K 26/0676; G02F 1/294; B23K 26/064

(57) ABSTRACT

An adjustment method of laser light path includes the steps of: having a laser light path to penetrate through a measuring device to obtain at least two laser focal positions of the laser light path, the at least two laser focal positions forming an arc path; applying a focal position-calculating device to calculate coordinate values of the at least two laser focal positions; based on the arc path and the coordinate values of the at least two laser focal positions to apply the focal position-calculating device to calculate a target laser focal position; and, based on the target laser focal position to apply a light modulator to adjust each of the at least two laser focal positions to the target laser focal position. In addition, an adjustment device of laser light path is also provided.

### CROSS REFERENCE TO RELATED APPLICATION

This application claims the benefits of Taiwan application Serial No. 110100014, filed on Jan. 4, 2021, the disclosures of which are incorporated by references herein in its entirety.

### TECHNICAL FIELD

The present disclosure relates in general to an adjustment method of laser light path and adjustment device of laser light path.

### BACKGROUND

While in applying laser cutting to process a glass substrate, a direction of the laser is usually adjusted to be coaxial with a normal direction of the glass substrate, such that a better cutting quality can be presented. However, as the application range of the laser cutting becomes more and more extensive, a glass substrate with an uneven surface may be met. Obviously, a curve surface of the glass substrate will not provide a unique normal direction, and thus performance of laser cutting upon a curve surface of the glass substrate on a traditional cutting platform by a traditional processing head would be unpredictable. To resolve this concern, an AC-axis processing head is introduced, and thus an expansive and complicated five-axis swing platform can be avoided.

Nevertheless, the AC-axis processing head can only overcome some problems in cutting a curve surface of the glass substrate. Generally speaking, as shown in FIG. 1A and FIG. 1B, a laser light path in an optical axis L11 passing a focusing lens 10 is schematically presented. In a normal situation, the optical axis L11 of the laser light path is coincided with an optical axis AX of the focusing lens 10. Thus, while the AC shaft is rotated, a laser focus P1 would be kept the same on a processing plane W. However, as shown in FIG. 2A and FIG. 2B, the optical axis L12 of the laser light path forms an angle AG to the optical axis AX of the focusing lens 10 (i.e., the laser light path is oblique). In this case, as the AC axis rotates, the laser light path passing the focusing lens 10 would form a laser focus P2 on the processing plane W, which is deviated from a preset focal position PZ. Further, while the processing head rotates about a C or A axis, different angles would be formed between the oblique laser light and the focusing lens, thereupon the oblique laser would generate different focal points on the processing plane W, and all of these focal points (P2 for example) would be deviated from the preset focal position PZ. In particular, as the processing head rotates 360° about the C or A axis, then the laser focus P2 corresponding the oblique laser light path along the optical axis L12 would form a circular trajectory on the processing plane W.

Apparently, a light-adjusting mechanism or method shall be introduced to substantially keep a fixed focal point on the processing plane while the laser processing head is rotated with the rotating shaft during a laser processing. In the art, a test specimen is firstly fixed to the processing plane, and several adjustment trials would be applied to the rotating shaft according to observations upon trajectories of the laser light path till satisfied trajectories of the focal points on the processing plane is achieved. Empirically, these trials would be cumbersome, and provide less information to determine whether or not the instant optical axis is inclined. Thus, an issue to provide an adjustment method of laser light path and an adjustment device of laser light path to resolve the aforesaid problems is definitely urgent to the skill in the art.

### SUMMARY

An object of the present disclosure is to provide an adjustment method of laser light path and an adjustment device of laser light path, that a target laser focal position can be obtained without a need of the traditional trial process to observe trajectories of focal points through a simulation process.

In one aspect of this disclosure, an adjustment method of laser light path includes: a step of having a laser light path to penetrate through a measuring device to obtain at least two laser focal positions of the laser light path, the at least two laser focal positions forming an arc path; a step of applying a focal position-calculating device to calculate coordinate values of the at least two laser focal positions; a step of based on the arc path and the coordinate values of the at least two laser focal positions, applying the focal position-calculating device to calculate a target laser focal position; and, a step of based on the target laser focal position, applying a light modulator to adjust each of the at least two laser focal positions to the target laser focal position.

In another embodiment of this disclosure, an adjustment method of laser light path includes: a step of having a laser light path to penetrate through a 2D measuring device to obtain a first laser focal position in a first direction and a first coordinate value in a second direction; a step of rotating the laser light path by an angle on the 2D measuring device from the first laser focal position to obtain a second laser focal position of the laser light path; a step of applying the 2D measuring device to obtain a second coordinate value of the second laser focal position in the first direction and the second direction; a step of, based on the first coordinate value and the second coordinate value, applying a focal position-calculating device to calculate a target laser focal position; and, a step of, based on the target laser focal position, applying a light modulator to adjust each of the first laser focal position and the second laser focal position to the target laser focal position.

In a further embodiment of this disclosure, an adjustment method of laser light path includes: a step of having a laser light path to penetrate through a 1D physical characteristics element in a 1D measuring device to obtain a first laser focal position corresponding to the laser light path, the 1D physical characteristics element having a given characteristics information; a step of applying an energy measuring element in the 1D measuring device to measure a first energy of the laser light path; a step of, based on the given characteristics information and the first energy of the laser light path, applying a focal position-calculating device to calculate a first coordinate value of a first laser focal position; a step of having the first coordinate value as a starting point to rotate the laser light path by an angle to provide a second laser focal position and correspondingly a second energy on the 1D physical characteristics element; a step of, based on the given characteristics information and the second energy of the laser light path, applying the focal position-calculating device to calculate a second coordinate value of a second laser focal position; a step of, based on the first coordinate value and the second coordinate value, applying a focal position-calculating device to calculate a target laser focal position; and, a step of, based on the target laser focal position, applying a light modulator to adjust the first laser focal position and the second laser focal position to the target laser focal position.

In another aspect of this disclosure, an adjustment device of laser light path includes a laser processing device, a measuring device, a focal position-calculating device and a light modulator. The laser processing device is configured for receiving a laser light path. The measuring device is connected with the laser processing device. The laser light path penetrates through the measuring device to form at least two laser focal positions, and the at least two laser focal positions form an arc path. The focal position-calculating device, connected with the measuring device, is to calculate coordinate values of the at least two laser focal positions and further a target laser focal position. The light modulator is connected with the laser processing device and the focal position-calculating device. Based on the target laser focal positions, the light modulator adjusts each of the at least two laser focal positions to the target laser focal position.

In another embodiment of this disclosure, an adjustment device of laser light path includes a laser processing device, a measuring device, a focal position-calculating device and a light modulator. The laser processing device is configured for receiving a laser light path. The 2D measuring device is connected with the laser processing device, the laser light path penetrates through the 2D measuring device to form at least two laser focal positions at a coordinate value in a first direction and a second direction, and the at least two laser focal positions form an arc path. The focal position-calculating calculating device, connected with the 2D measuring device, is to evaluate the coordinate value of the at least two laser focal positions in the first direction and to adjust each of the at least two laser focal positions to the target laser focal position.

In a further embodiment of this disclosure, an adjustment device of laser light path includes a laser processing device, a 1D measuring device, a focal position-calculating device and a light modulator. The laser processing device is configured for receiving a laser light path. The 1D measuring device, connected with the laser processing device, provides a given characteristics information, and obtains first energy of at least two laser focal positions formed by the laser light path to penetrate through the 1D measuring device. The focal position-calculating device, connected with the 1D measuring device, is to evaluates the given characteristics information and the first energy of the at least two laser focal positions of the laser light path to calculate coordinate values of the at least two laser focal positions and to further calculate a target laser focal position according to the coordinate values of the at least two laser focal positions. The light modulator, connected with the laser processing device and the focal position-calculating device, is to adjust each of the at least two laser focal positions to the target laser focal position.

As stated, through the steps for providing at least two laser focal positions of the laser light path and the resulted arc path formed by the at least two laser focal positions in accordance with this disclosure, it can be determined whether or not the optical axis of the laser light path is oblique. Thus, real processing is not necessary to observe the focal position. In addition, based on the arc path and the coordinate values of the corresponding laser focal positions, the target laser focal position to satisfy the demand in light adjustment can be obtained.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1A demonstrates schematically an embodiment of a laser light path in the art;

FIG. 1B is a schematic view of a focal point on a processing plane for FIG. 1A;

FIG. 2A demonstrates schematically another embodiment of a laser light path in the art;

FIG. 2B is a schematic view of a focal point on a processing plane for FIG. 2A;

FIG. 3 is a schematic block view of an embodiment of the adjustment device of laser light path in accordance with this disclosure;

FIG. 4 shows schematically a flowchart of an embodiment of the adjustment method of laser light path in accordance with this disclosure;

FIG. 5A illustrates schematically a step of FIG. 4;

FIG. 5B illustrates schematically another step of FIG. 4;

FIG. 6A is a schematic view of an embodiment of the laser processing device in accordance with this disclosure;

FIG. 6B is a schematic view of another embodiment of the laser processing device in accordance with this disclosure;

FIG. 7 is a schematic block view of another embodiment of the adjustment device of laser light path in accordance with this disclosure;

FIG. 8 shows schematically a flowchart of another embodiment of the adjustment method of laser light path in accordance with this disclosure;

FIG. 9A illustrates schematically a step of FIG. 8;

FIG. 9B illustrates schematically another step of FIG. 8;

FIG. 9C illustrates schematically a further step of FIG. 8;

FIG. 10 is a schematic block view of a further embodiment of the adjustment device of laser light path in accordance with this disclosure;

FIG. 11 shows schematically a flowchart of a further embodiment of the adjustment method of laser light path in accordance with this disclosure;

FIG. 12 is a schematic view of an embodiment of the 1D physical characteristics element of FIG. 10;

FIG. 13A demonstrates schematically a first laser focal position in the first direction of FIG. 11;

FIG. 13B shows schematically an example of the physical characteristics curve changing information for different lengths of the 1D physical characteristics element with respect to the corresponding penetration rates in the first direction of FIG.11, specifically at the first penetration rate;

FIG. 13C illustrates the first laser focal position with respect to the first length in the first direction of FIG. 13B;

FIG. 14A illustrates schematically that the first laser focal position is rotated to the second laser focal position of FIG. 11;

FIG. 14B shows schematically an example of the physical characteristics curve changing information for different lengths of the 1D physical characteristics element with respect to the corresponding penetration rates in the first direction of FIG.11, specifically at the second penetration rate;

FIG. 14C illustrates the first laser focal position with respect to the second length in the first direction of FIG. 14B;

FIG. 15A illustrates schematically an embodiment of calculating the target laser focal position in the first direction of FIG. 11;

FIG. 15B shows schematically an example of the physical characteristics curve changing information for different lengths of the 1D physical characteristics element with respect to the corresponding penetration rates in the first direction of FIG.11, specifically at the third length;

FIG. 15C illustrates schematically an embodiment of adjusting the laser focal position to the calculated target laser focal position in the first direction of FIG. 11;

FIG. 16A demonstrates schematically a first laser focal position in the second first direction of FIG. 11;

FIG. 16B shows schematically an example of the physical characteristics curve changing information for different lengths of the 1D physical characteristics element with respect to the corresponding penetration rates in the second direction of FIG.11, specifically at the second penetration rate;

FIG. 16C illustrates schematically the second laser focal position with respect to the second length in the second direction of FIG. 16B;

FIG. 17A illustrates schematically the second laser focal position in the second direction of FIG. 11;

FIG. 17B shows schematically an example of the physical characteristics curve changing information for different lengths of the 1D physical characteristics element with respect to the corresponding penetration rates in the second direction of FIG.11, specifically at another second penetration rate;

FIG. 17C illustrates schematically the second laser focal position with respect to the second length in the second direction of FIG. 17B;

FIG. 18A illustrates schematically an embodiment of calculating the target laser focal position in the second direction of FIG. 11;

FIG. 18B shows schematically an example of the physical characteristics curve changing information for different lengths of the 1D physical characteristics element with respect to the corresponding penetration rates in the second direction of FIG.11, specifically at the third length; and

FIG. 18C illustrates schematically an embodiment of adjusting the laser focal position to the calculated target laser focal position in the second direction of FIG. 11.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

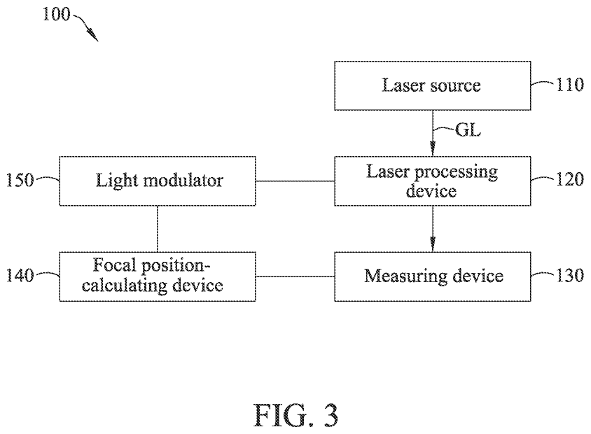

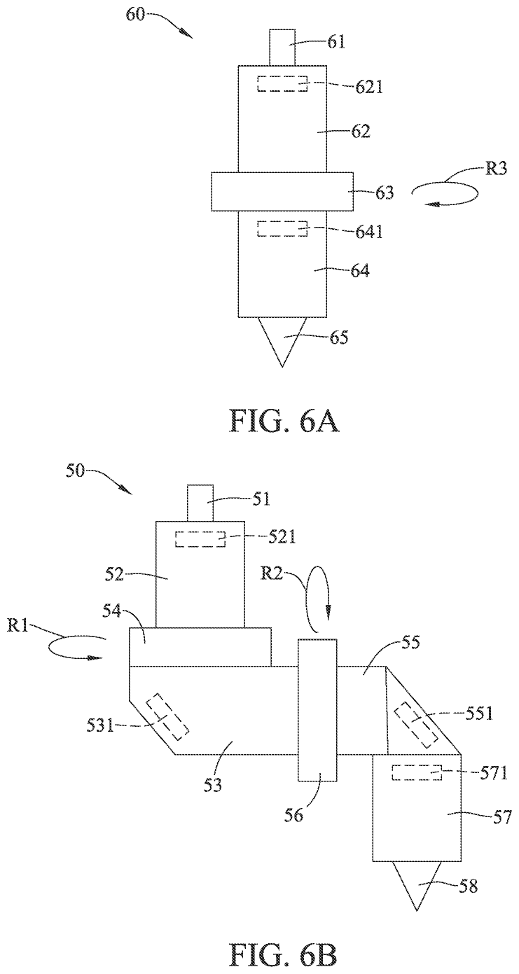

FIG. 3 is a schematic block view of an embodiment of the adjustment device of laser light path in accordance with this disclosure. As shown, the adjustment device of laser light path 100 includes a laser source 110, a laser processing device 120, a measuring device 130, a focal position-calculating device 140 and a light modulator 150. In this embodiment, the measuring device 130, the focal position-calculating device 140 or the light modulator 150 are not limited any specific type. The laser processing device 120 includes at least a focusing lens and a rotating shaft. The laser source 110 is used for generating a laser light path GL for the laser processing device 120. The laser processing device 120 can be embodied as a single-axis pendulum as shown in FIG. 6A or a multi-axis pendulum as shown in FIG. 6B.

In this embodiment, the measuring device 130, connected with the laser processing device 130, is used for measuring the laser focal position of the laser light path GL. The focal position-calculating device 140, connected with the measuring device 130, is used for calculating coordinate values of the laser focal position. The light modulator 150, connected with the laser processing device 120 and the focal position-calculating device 140, is used for adjusting the laser focal position to a target laser focal position so as to obtain a preferable light-focusing quality.

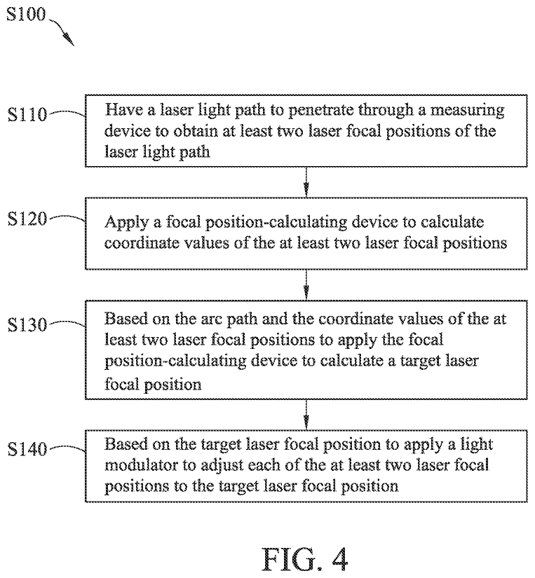

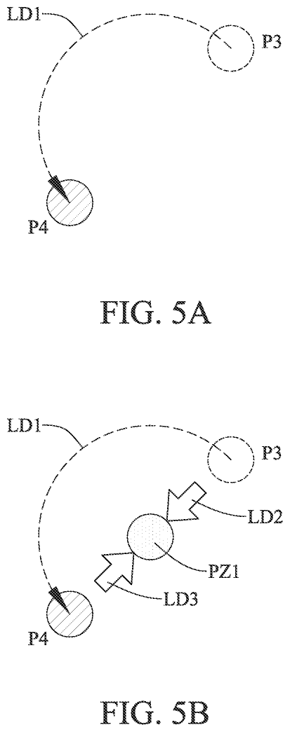

FIG. 4 shows schematically a flowchart of an embodiment of the adjustment method of laser light path in accordance with this disclosure, FIG. 5A illustrates schematically a step of FIG. 4, and FIG. 5B illustrates schematically another step of

FIG. 4. Referring to FIG. 4 and FIG. 3, in this embodiment, the adjustment method of laser light path S100 includes Step S110 to Step S140 as follows. Firstly, the laser source 110 is applied to construct a laser light path GL to the laser processing device 120. Then, Step S110 is performed to have the laser light path GL to penetrate through the measuring device 130, so that at least two focal positions of the laser light path can be obtained to form an arc path.

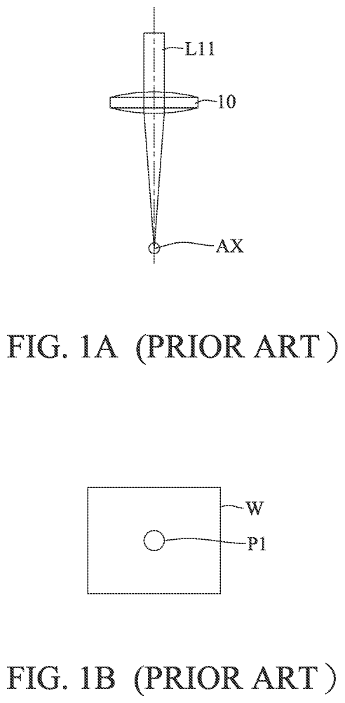

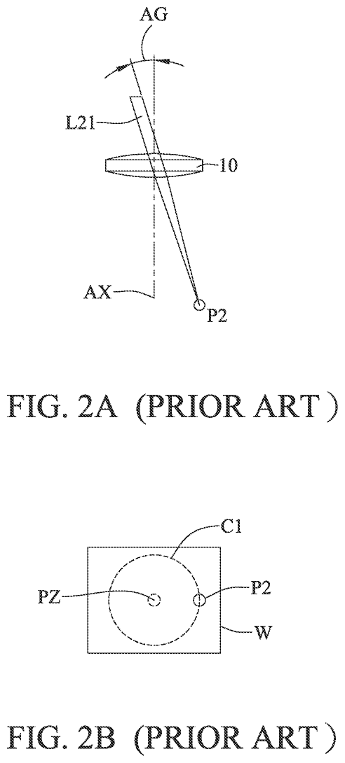

In detail, by having FIG. 5A as an example and also referring to FIG. 1, after the laser light path GL to the laser processing device 120 is generated by the laser source 110, then the measuring device 130 is applied to obtain a first laser focal position P3 of the laser light path GL. Then, a rotating shaft is rotated to change the focal position of the laser light path GL. Then, the measuring device 130 is also used to obtain a second laser focal position P4 of the after the rotation. With the first laser focal position P3 and the second laser focal position P4, an arc path LD1 can be formed.

In one embodiment of this disclosure, the step of rotating the rotating shaft includes a following step of having the measuring device 130 to determine whether or not an optical axis of a focusing lens is coincided with the first laser focal position. If positive, then a light-adjusting step is not necessary. Otherwise, perform a step of having the first laser focal position P3 as a starting point to rotate about the optical axis of the focusing lens, so that the second laser focal position P4 can be obtained. It shall be explained that, if the rotation angle is 180°, an arc path LD1 can be obtained.

In one embodiment, the foregoing step can be executed by a single-axis pendulum mechanism or a multi-axis pendulum mechanism. Referring to FIG. 6A, a schematic view of an embodiment of the laser processing device in accordance with this disclosure is shown. In this embodiment, the laser processing device 60 is embodied as a single-axis pendulum mechanism to include a laser connector 61, a first part 62, a rotation portion 63, a second part 64 and a laser processing head 65, in which the first part 62 and the second part 64 are united to form a housing for accommodating the rotation portion 63.

The optical lens 621 is disposed in the first part 62, the focusing lens 641 is disposed in the second part 64, and the rotation portion 63 is located between the optical lens 621 and the focusing lens 641. Upon such an arrangement, the laser light transmitted from the laser connector 61 can pass through the optical lens 621, such that the laser light can be projected onto the focusing lens 641 and then leave the single-axis pendulum mechanism via the laser processing head 65. While the aforesaid laser light is reflected to the focusing lens 641, the rotation portion 63, as the rotating shaft for the laser processing head 65, can rotate in a rotation direction R3. As such, the single-axis pendulum mechanism can be adopted into this disclosure as a practical device for rotating the rotating shaft in the corresponding step of this disclosure.

Nevertheless, this disclosure is not limited thereto. In another embodiment, referring to FIG. 6B, a schematic view of another embodiment of the laser processing device in accordance with this disclosure is shown. In this embodiment, the laser processing device 50 is embodied as a multi-axis pendulum mechanism to include a laser connector 51, a first part 52, a second part 53, a third part 55, a fourth part 57, a first rotation portion 54, a second rotation portion 56 and a laser processing head 58. In particular, the first part 52, the second part 53, the third part 55 and the fourth part 57 are integrated to form a housing for accommodating thereinside the first rotation portion 54 between the first part 52 and the second part 53 as a mechanism of the first rotating shaft, and thereinside also the second rotation portion 56 between the second part 53 and the third part 55 as another mechanism of the second rotating shaft. In addition, the first rotation direction R1 of the first rotation portion 54 is different from the second rotation direction R2 of the second rotation portion 56. In one exemplary example, the laser processing device 50 can be an A-axis processing head, in which the first rotation portion 54 is used as a rotating mechanism of the C axis, and the second rotation portion 56 is used as a rotating mechanism of the A axis.

In this embodiment, the optical lens 521 is disposed in the first part 52, the first mirror 531 is disposed in the second part 53, the first rotation portion 54 is located between the optical lens 521 and the first mirror 531, the second mirror 551 is located between the third part 55 and the fourth part 57, the second rotation portion 56 is located between the first mirror 531 and the second mirror 551, and the focusing lens 571 is located between the second mirror 551 and the laser processing head 58. Upon such an arrangement, the laser light transmitted from the laser connector 51 can reach the first mirror 531 via the optical lens 521. After passing through the first mirror 531 and the second mirror 551, the laser light would be reflected to the focusing lens 571, and then leaves the laser processing head 58. During the laser light is reflected to the focusing lens 571, the first rotation portion 54 as the first rotating shaft of the laser processing head 58 can rotate in a first rotation direction R1, and the second rotation portion 56 as the second rotating shaft of the laser processing head 58 can rotate in a second rotation direction R2. In other words, the multi-axis pendulum mechanism can be adopted into this disclosure as a practical device for rotating the first rotation portion 54 or the second rotation portion 56 in the corresponding step of this disclosure.

Referring to FIG. 4 and FIG. 3, after Step S110, then Step S120 is performed to apply the focal position-calculating device 140 to calculate a coordinate value value of each of the laser focal positions. By having FIG. 5A as an example, the focal position-calculating device 140 is utilized to calculate the coordinate values for the first laser focal position P3 and the second laser focal position P4. In this disclosure, the embodiment of the focal position-calculating device 140 is not limited to calculate only two laser focal positions. In an embodiment not shown herein, three or four laser focal positions can be obtained by rotating the rotating shaft.

After the coordinate value for each of the laser focal positions is calculated in Step S120, then Step S130 is performed to have the focal position-calculating device 140 to calculate a target laser focal positions by evaluating the arc path LD1 and each of the coordinate values of the laser focal positions. By having FIG. 5B as example, the focal position-calculating device 140 would determine a circle center position of the arc path LD1 in accordance with the coordinate value of the first laser focal position P3, the coordinate value of the second laser focal position P4, and the arc path LD1. As shown, the circle center position is the target laser focal position PZ1.

After the target laser focal position PZ1 is obtained in Step S130, then Step S140 is performed to have a light modulator 150 to adjust each individual laser focal position to the target laser focal position PZ1. By having FIG. 5B as an example, since each of the laser focal positions does not coincide with the optical axis of the focusing lens, thus the target laser focal position PZ1 obtained by performing Step S110 through Step S130, is the optical axis of the focusing lens. Then, the light modulator 150 adjusts the optical axis of the laser light path GL so as to have the second laser focal position

P4 to move to the target laser focal position PZ1 along the adjustment path LD3. Similarly, if the final focal position is at the first laser focal information, then the light modulator 150 would adjust the optical axis of the laser light path GL to move the first laser focal position P3 to the target laser focal position PZ1 along the adjustment path LD2.

Upon the aforesaid arrangement, in this embodiment, in accordance with the at least two laser focal positions of the laser light path and the resulted arc path, it can be determined whether or not the optical axis of the laser light path is oblique. Thus, the real processing is not necessary to observe the focal position. Contrarily, based on the arc path and the coordinate values of the corresponding laser focal positions, the target laser focal position for adjusting the light can be derived.

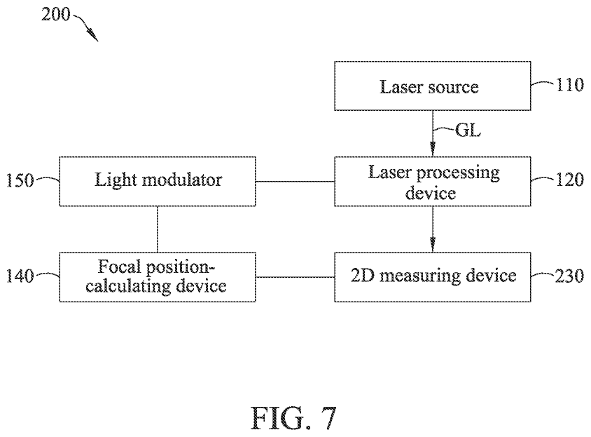

FIG. 7 is a schematic block view of another embodiment of the adjustment device of laser light path in accordance with this disclosure. As shown, it shall be explained that the adjustment device of laser light path 200 of FIG. 7 is similar to that 100 of FIG. 3, in which the same elements are assigned by the same numbers, and details thereabout are omitted herein. In the following description only differences between FIG. 3 and FIG. 7 are elucidated. The major difference between the adjustment device of laser light path 200 of FIG. 7 and the adjustment device of laser light path 100 of FIG. 3 is at the 2D measuring device 230 in the adjustment device of laser light path 200 of FIG. 7.

In this embodiment, the 2D measuring device 230, connected with the laser processing device 120, can directly measure the 2D coordinate values of the laser focal positions. The 2D measuring device 230 can be, but not limited to, a beam profiler. In other embodiments, the 2D measuring device 230 can be a position-sensitive diode (PSD).

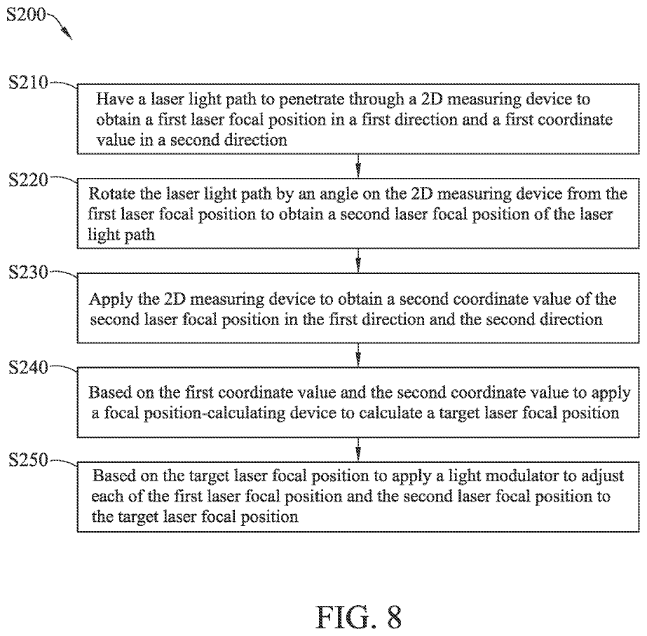

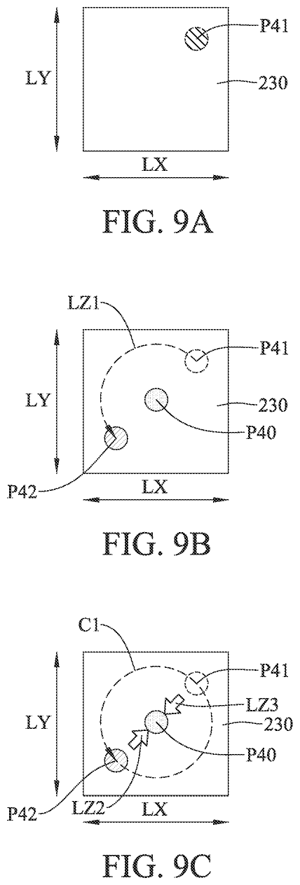

FIG. 8 shows schematically a flowchart of another embodiment of the adjustment method of laser light path in accordance with this disclosure. FIG. 9A illustrates schematically a step of FIG. 8. FIG. 9B illustrates schematically another step of FIG. 8. FIG. 9C illustrates schematically a further step of FIG. 8. Referring to FIG. 8 and FIG. 7, the adjustment method of laser light path S200 includes Step S210 to

Step S250 as follows. Firstly, the laser source 110 for generating laser light is used to construct a laser light path GL to the laser processing device 120. Then, referring to FIG. 9A, Step S210 is performed to have the laser light path GL to pass through a 2D measuring device 230, so that a first laser focal position P41 can be obtained. In other words, the first coordinate value in both a first direction LX and a second direction LY (i.e., the 2D coordinate) for the first laser focal position P41 where the laser light path GL passes through the 2D measuring device 230 can be measured by the 2D measuring device 230.

In one embodiment, Step S210 includes a step of: adopting a beam profiler or a position-sensitive diode to be the 2D measuring device 230. That is, the beam profiler or the position-sensitive diode can be used as the 2D measuring device 230 of this embodiment, but not limited thereto.

Then, referring FIG. 9B, in performing Step S220, have the first laser focal position P41 with the first coordinate value as a starting point to rotate an angle so as to generate a second laser focal position P42 of the laser light path GL on the 2D measuring device 230. Thus, an arc path LZ1 can be formed from the first laser focal position P41 to the second laser focal position P42.

In one embodiment, the step of rotating an angle to have laser light path to form a second laser focal position P42 on the 2D measuring device 230 includes a step of: utilizing the 2D measuring device 230 to determine whether or not an optical axis of a focusing lens is coincided with the first laser focal position. If positive, then no light adjustment is required. Otherwise, the following step is performed to rotate the laser light path GL about the optical axis of the focusing lens from the first laser focal position P41 (as the starting point of the rotation) so as to obtain the second laser focal position P42. It shall be explained that the rotation angle can be 180° for forming the arc path LD1. In one embodiment, the aforesaid step can be integrated with the aforesaid single-axis or multi-axis pendulum mechanism, as shown in FIG. 6A and FIG. 6B.

After Step S220, then, in performing Step S230, have the 2D measuring device 230 to obtain a second coordinate value of the second laser focal position P42 in both the first direction LX and the second direction LY. Then, in performing Step S240, based on the first coordinate value of the first laser focal position P41 and the second coordinate value of the second laser focal position P42, a focal position-calculating device 140 is applied to calculate a target laser focal position P40. In this disclosure, the embodiment of the focal position-calculating device 140 is not limited to calculate only two laser focal positions. In an embodiment not shown herein, three or four laser focal positions can be obtained by rotating the rotating shaft.

After Step S230 has been performed to calculate the coordinate value for each of the laser focal positions, Step S240 is performed to have the focal position-calculating device 140 to calculate a target laser focal position according to the arc path LZ1 and all coordinate values of the corresponding laser focal positions. By having FIG. 9B as an example, the focal position-calculating device 140 evaluates the first coordinate value of the first laser focal position P41, the second coordinate value of the second laser focal position P42, and the arc path LZ1 to derive a center position of the arc path LX1 i.e., the target laser focal position P40.

After Step S240 has been performed to obtain the target laser focal position P40, then Step S250 is performed to have a light modulator 150 to adjust each of the laser focal positions to the target laser focal position P40 according to the target laser focal position P40. By having FIG. 9C as an example, since it is assumed in this disclosure that the laser focal position is not coincided with the optical axis of the focusing lens, thus the target laser focal position P40 obtained by performing the aforesaid Step S210 to Step S240 is deemed as the optical axis of the focusing lens.

Then, the light modulator 150 adjusts the optical axis of the laser light path GL by moving the second laser focal position P42to the target laser focal position PZ1 along the adjustment path LZ2. Similarly, if the instant focal point falls at the first laser focal position P41, then the light modulator 150 adjust the optical axis of the laser light path GL by moving the first laser focal position P41 to the target laser focal position P40 along the adjustment path LZ3. Of course, in other embodiments, for all the laser focal positions within the circular range C1 obtained through rotation from the first laser focal position P41, the light adjustment can be achieved by performing the aforesaid step.

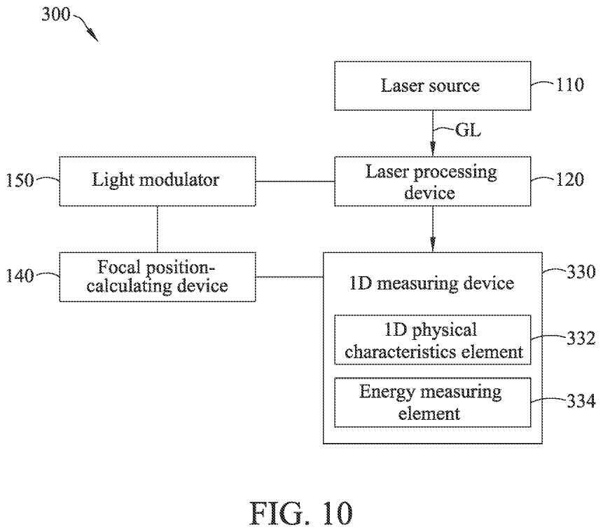

FIG. 10 is a schematic block view of a further embodiment of the adjustment device of laser light path in accordance with this disclosure. As shown, it shall be explained that the adjustment device of laser light path 300 of FIG. 10 is similar to the adjustment device of laser light path 100 of FIG. 3 or the adjustment device of laser light path 200 of FIG. 7, in which elements with the functions are assigned by the same numbers, and thus details thereabout would be omitted herein. In the following description, only differences between the adjustment device of laser light path 300 of FIG. 10 and any of the adjustment device of laser light path 100 of FIG. 3 and the adjustment device of laser light path 200 of FIG. 7 would be elucidated. The major difference between the device 300 of FIG. 10 and that 100 of FIG. 3 or that 200 of FIG. 7 is that, in FIG. 10, the adjustment device of laser light path 300 further has a measuring device 330.

In this embodiment, the 1D measuring device 330, connected with the laser processing device 120, provides a given characteristics information. In detail, the measuring device 330 includes a 1D physical characteristics element 332 and an energy measuring element 334, in which the 1D physical characteristics element 332 in the laser processing device 120 is located between the focusing lens and the energy measuring element 334.

In this embodiment, the 1D physical characteristics element 332 is an element that presents a plurality of different physical characteristics changes in one dimension space (i.e., in a unique direction). For example, those elements with a plurality of different penetration-rate changes in a 1D direction include a continuous filter whose penetration rate is decreased gradually in a longitudinal direction. Namely, the continuous filter is provided with a physical characteristics curve changing information. Since penetration rates of the continuous filter in a particular direction are now given, thus the physical characteristics curve changing information is a given characteristics information.

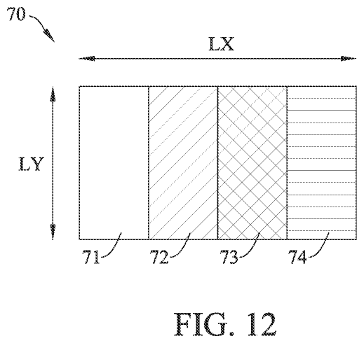

By having FIG. 12 as an example, a 1D physical characteristics element 70 is disclosed to have different physical characteristics (such as the penetration rate) in the first direction LX. The 1D physical characteristics element 70 includes a first section 71, a second section 72, a third section 73 and a fourth section 74, in which the first section 71, the second section 72, the third section 73 and the fourth section 74 stand individually for different physical characteristics in the penetration rate.

Further, the penetration rates in the first section 71, the second section 72, the third section 73 and the fourth section 74 are increased gradually to demonstrate a 1D energy changing element. Of course, this disclosure is not limited thereto. In an embodiment not shown herein, the first section 71, the second section 72, the third section 73 and the fourth section 74 stands orderly for sections with decreasing penetration rates. In another embodiment also not shown herein, the first section 71, the second section 72, the third section 73 and the fourth section 74 stands orderly for sections with increasing penetration rates, or interlacing penetration rates. In a further embodiment, the 1D physical characteristics element 70 may include three, five, six, seven or the like number of sections with different physical characteristics.

In this embodiment, the energy measuring element 334, disposed under the 1D physical characteristics element 332, is used for measuring energy of the laser light travelling along the laser light path GL to pass through the physical characteristics element 332. The focal position-calculating device 140, connected with the 1D measuring device 330, calculate a coordinate value of the laser focal position according to the energy of the laser light travelling along the laser light path GL and the given characteristics information of the physical characteristics curve changing information provided by the 1D physical characteristics element 332, in which the physical characteristics curve changing information can be the penetration rate with respect to a specific length.

In detail, since the energy capacity for the laser light path GL to carry along is given, thus the energy of the laser light passing the 1D physical characteristics element 332 along the laser light path GL can be compared with the energy capacity of the laser light path GL so as to derive the penetration rate according to the detected energy. Then, the coordinate value of the laser focal position can be estimated through the physical characteristics curve changing information of the 1D physical characteristics element 332.

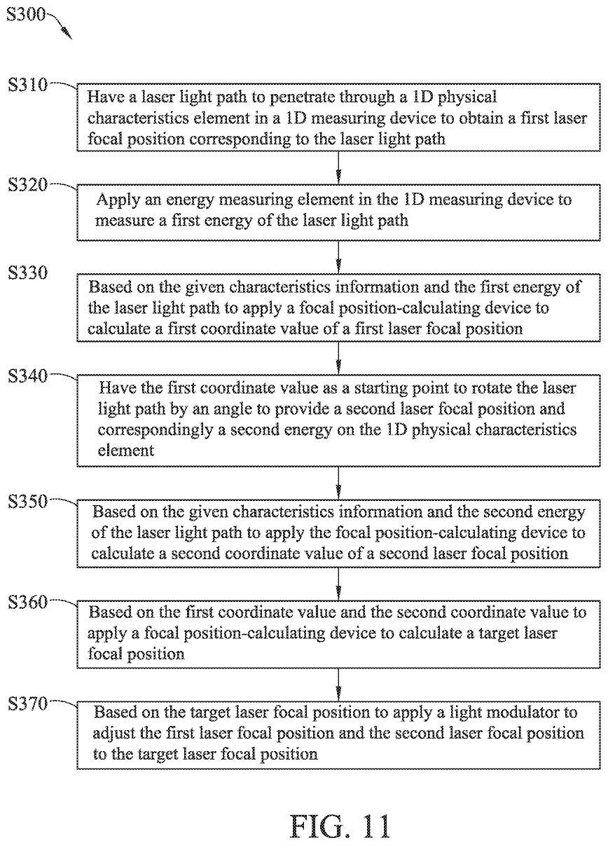

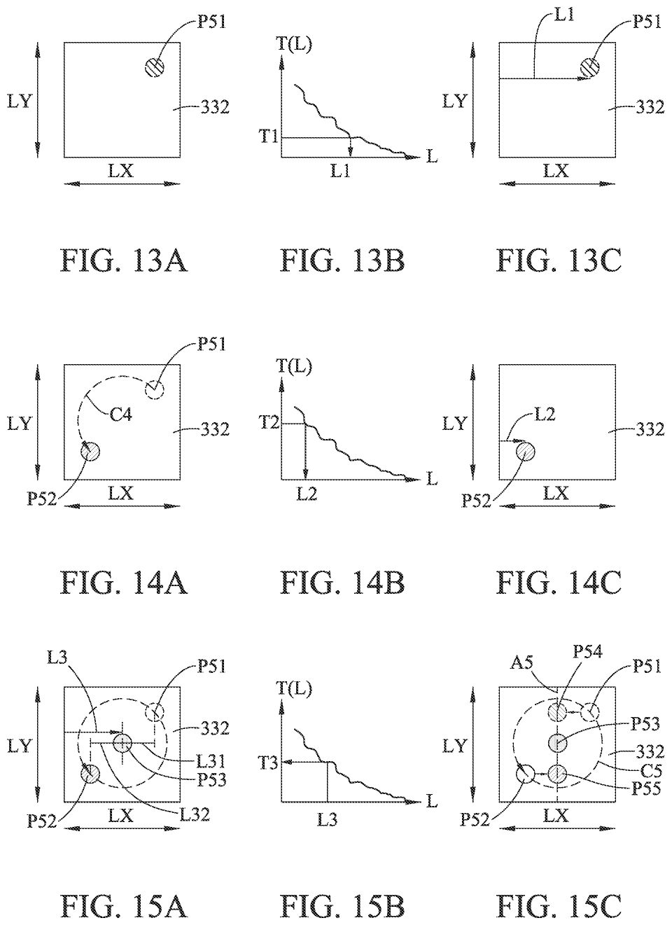

FIG. 11 shows schematically a flowchart of a further embodiment of the adjustment method of laser light path in accordance with this disclosure. Referring to FIG. 10 and FIG. 11, in this embodiment, the adjustment method of laser light path S300 includes Step S310 to Step S370 as follows. Firstly, the laser source 110 is used for generating a laser light path GL to the laser processing device 120 for laser light emitted thereby to travel therealong. Then, in performing Step S310, referring to FIG. 13A and FIG. 10, the laser light path GL passes through a 1D physical characteristics element 332 of a 1D measuring device 330 so as to obtain a first laser focal position P51 corresponding to the laser light path GL, in which the 1D physical characteristics element 332 has a given characteristics information.

In one embodiment, Step S310 includes a step of: adopting a 1D physical characteristics element 332 who has a plurality of different penetration rates in a 1D direction. For example, in FIG. 13A, FIG. 14A and FIG. 15A, the 1D physical characteristics element 332 includes a plurality of different penetration rates in the first direction LX.

In addition, Step S310 further includes a step of: adopting a physical characteristics curve changing information having relationships between the lengths and the penetration rates as the given characteristics information. For example, the 1D physical characteristics element 332 is an element having changes of a plurality of different penetration rates in a 1D direction, such as a continuous filter who has the physical characteristics curve changing information of lengths with respect to the penetration rates. Since the continuous filter has different given penetration rates along a direction, thus the physical characteristics curve changing information can be seen as a given characteristics information.

Referring to FIG. 11, in performing Step S320 after Step S310, an energy measuring element 334 of the 1D measuring device 330 is applied to measure a first energy at the laser light path GL. Then, in performing Step S330, referring to FIG. 10, FIG. 13B and FIG. 13C, a focal position-calculating device 140 is applied to calculate a first coordinate value of a first laser focal position P51 according to the given characteristics information and the first energy of the laser light path GL.

In detail, Step S330 includes a step of: evaluating the first energy at the first laser focal position P51 to derive the first penetration rate of the laser light path GL passing the 1D physical characteristics element 332. According to the physical characteristics curve changing information provided by the 1D physical characteristics element 332 and the first penetration rate, the first coordinate value of the first laser focal position P51 in the first direction LX can be obtained. Since the energy capacity for the laser light path GL to carry along is given, thus the energy of the laser light passing the 1D physical characteristics element 332 along the laser light path GL can be compared with the energy capacity of the laser light path GL so as to derive the penetration rate according to the detected energy.

For example, as shown in FIG. 13B, the physical characteristics curve changing information for the penetration rate T with respect to the length L of the 1D physical characteristics element 332 is provided. Based on the first penetration rate T1 of the first laser focal position P51 derived previously, and further the first penetration rate T1 in FIG. 13B, the length L in the first direction LX is the first length L1. From FIG. 13C, the X coordinate value of the first laser focal position P51 in the first direction LX is the value of the first length L1.

Then, after Step S330, then Step S340 is performed. Referring to FIG. 10 and

FIG. 14A, have the first laser focal position P51 with the first coordinate value as a starting point to rotate an angle so as to generate a second laser focal position P52 of the laser light path GL and a corresponding second energy on the 1D physical characteristics element 332. Thus, an arc path C6 can be formed from the first laser focal position P61 to the second laser focal position P62.

It shall be explained that, in Step S340, the rotation angle can be 180° for forming the arc path LD1. In one embodiment, the aforesaid step can be integrated with the aforesaid single-axis or multi-axis pendulum mechanism, as shown in FIG. 6A and FIG. 6B. In one embodiment, Step S340 includes a step of: utilizing an energy measuring element 334 in the 1D measuring device 330 to measure a second energy at the second laser focal position P52 of the laser light path GL.

After Step S340, then in performing Step S350, referring to FIG. 10, FIG. 14B and FIG. 14C, a focal position-calculating device 140 is used to calculate a second coordinate value of a second laser focal position P52 according to the given characteristics information and the second energy of the laser light path GL.

In detail, Step S350 includes the step of: as shown in FIG. 14B, evaluating the second energy of the second laser focal position P52 to derive the second penetration rate T2 of the laser light path GL while passing through the 1D physical characteristics element 332. Then, based on the physical characteristics curve changing information and the second penetration rate T2 provided by the 1D physical characteristics element 332, the second coordinate value of the second laser focal position P52 in the first direction LX can be obtained. With the second length L2, i.e., the length L of the second laser focal position P52 in the first direction LX, then, as shown in FIG. 14C, the X coordinate value of the second laser focal position P52 in the first direction LX is the value of the second length L2.

After Step S350, in performing Step S360, referring to FIG. 10 and FIG. 15A, a focal position-calculating device 140 is utilized to calculate a target laser focal position P53 according to the first coordinate value of the first laser focal position P51 and the second coordinate value of the second laser focal position P52. Step S350 includes the step of: the focal position-calculating device 140 evaluating the first coordinate value of the first laser focal position P51, the second coordinate value of the second laser focal position P52, and the arc path C4 to derive the third coordinate value of the center position of the arc path C4, in which the center position is the target laser focal position P53. As shown in FIG. 15A, the first laser focal position P51 is spaced from the target laser focal position P53 in the first direction LX is a first distance L31, the second laser focal position P52 is spaced from the target laser focal position P53 in the first direction LX is a second distance L32, and the first distance L31 is equal to the second distance L32. The third coordinate value of the target laser focal position P53 in the first direction LX is defined as a third length L3. Then, based on the physical characteristics curve changing information provided by the 1D physical characteristics element 332 and the third length L3 of the target laser focal position P53, the third penetration rate T3 of the target laser focal position P53 in the first direction LX can be obtained. Further, based on the energy at the laser light path GL after passing the 1D physical characteristics element 332 and the third penetration rate T3, an energy adjustment value can be derived in a reverse manner.

From the aforesaid Step S310 to Step S360, the target laser focal position P53 can be derived, and this position is the position of the optical axis of the focusing lens. In performing Step S370, referring to FIG. 10 and FIG. 15C, based on the target laser focal position P53, a light modulator 150 is utilized to adjust the first laser focal position P51 and the second laser focal position P52 to the target laser focal position P53.

Practically, since at the present time only the third coordinate value of the target laser focal position P53 in the first direction LX is known, thus the inclination angle of the optical axis of the laser light path GL can be adjusted according to the aforesaid derived energy adjustment value, so that the adjustment value to satisfy the demand can be obtained. Accordingly, the second laser focal position P52 would be moved to a second target laser focal position P55. Similarly, if at the present time the final focal position is at the first laser focal position P51, the light modulator 150 would adjust the optical axis of the laser light path GL to move the first laser focal position P51 to a first target laser focal position P54, in which the first target laser focal position P54, the second target laser focal position P55 and the target laser focal position P53 are connected to form a straight line A5 in the second direction LY. Namely, the coordinate values of the first target laser focal position P54, the second target laser focal position P55 and the target laser focal position P53 are the same in the first direction LX. Of course, in some other embodiments, for all the laser focal positions within the circular range C5 obtained through rotation from the first laser focal position P51, the light adjustment can be achieved by performing the aforesaid step.

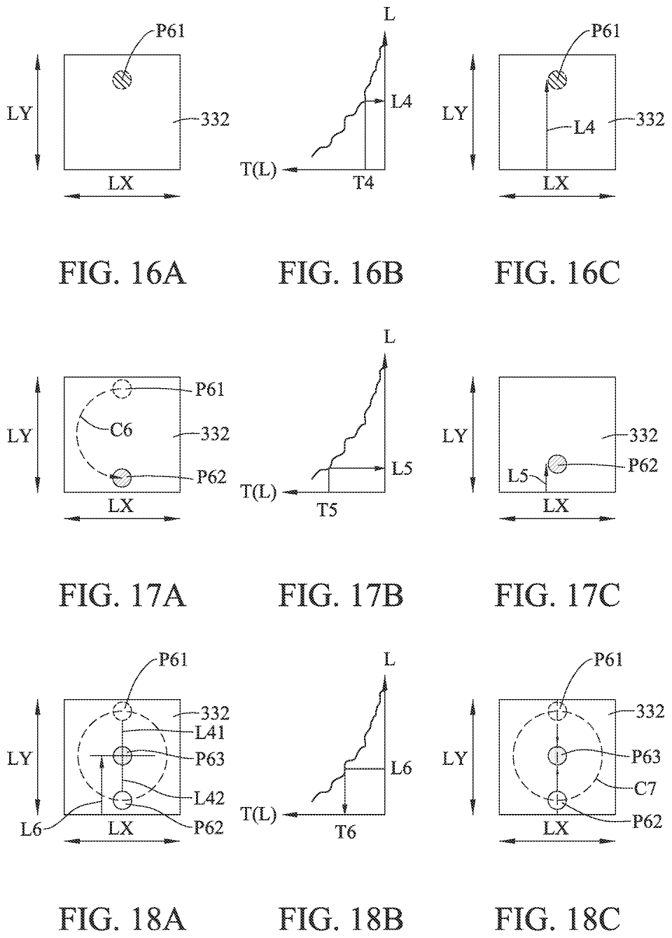

After completing Step S370 for light adjustment in the first direction LX, a following step is further included to rotate the 1D physical characteristics element 332 by an angle, 90° for example, so as to furnish the 1D physical characteristics element 332 with a plurality of different penetration rate changes in the second direction LY. In other words, from FIG. 13A to FIG. 15C, the light adjustment in the second direction LY is achieved through the plurality of different penetration rate changes of the 1D physical characteristics element 332 in the first direction LX. After the 1D physical characteristics element 332 is rotated by a 90° to switch a state that the 1D physical characteristics element 332 has a plurality of different penetration rates in the first direction LX into another state that the 1D physical characteristics element 332 has a plurality of different penetration rates in the second direction LY. Namely, the 1D physical characteristics element 332 in FIG. 16A, FIG. 17A or FIG. 18A would have a plurality of different penetration rates in the second direction LY. Hence, the laser light path GL is in correspondence with a plurality of different penetration rate changes in the second direction LY.

In this embodiment, after the aforesaid step to rotate the 1D physical characteristics element 332 by 90°, then repeat Step S310 to Step S370. Referring to FIG. 10 and FIG. 16A, the laser light path GL passes through the 1D physical characteristics element 332 in the 1D measuring device 330 so as to obtain the first laser focal position P61 corresponding to the laser light path GL (Step S310), an energy measuring element 334 is applied to measure the first energy of the laser light path GL (Step S320), and then the focal position-calculating device 140 is utilized to calculate the first coordinate value of the first laser focal position P61 according to the given characteristics information and the first energy of the laser light path GL (Step S330).

In addition, the first penetration rate T4 of the first laser focal position P51 can be obtained accordingly. Further, from the first penetration rate T4 of FIG. 16B. it can be seen that the length L in the second direction LY is the first length L4. Also, as shown in FIG. 16C, the Y coordinate value of the first laser focal position P61 in the second direction LY is the first length L4.

Then, have the first laser focal position P6 with the first coordinate value as the starting point to rotate an angle so as to have the laser light path GL furnished with a second laser focal position P62 and a corresponding second energy on the 1D physical characteristics element 332 (Step S340), in which the rotation angle can be 180°. Similarly, based on the given characteristics information and the second energy of the laser light path GL, a focal position-calculating device 140 is utilized to calculate the second coordinate value of the second laser focal position P62. The second penetration rate T5 of the laser light path GL passing through the 1D physical characteristics element 332 can be derived from the second energy of the second laser focal position P62. Based on the physical characteristics curve changing information provided by the 1D physical characteristics element 332 and the second penetration rate T5, the second coordinate value of the second laser focal position P62 in the second direction LY can be obtained. Following the steps to determine that the length L of the second laser focal position P62 in the second direction LY is the second length L5, as shown in FIG. 17C, the Y coordinate value of the second laser focal position P62 in the second direction LY is the value of the second length L5.

Then, the focal position-calculating device 140 is used to calculate a target laser focal position P63 according to the first coordinate value of the first laser focal position P61 and the second coordinate value of the second laser focal position P62 (Step S350). As shown in FIG. 17A, the first laser focal position P61 is spaced from the target laser focal position P63 in the second direction LY by the first distance L41, the second laser focal position PY2 is spaced from the target laser focal position P63 in the second direction LY by the second distance L42, and the first distance L41 is equal to the second distance L42. In addition, the third coordinate value of the target laser focal position P63 in the second direction LY is defined to be a third length L6. Thereupon, based on the physical characteristics curve changing information provided by the 1D physical characteristics element 332 and the third length L6 of the target laser focal position P63, the third penetration rate T6 of the target laser focal position P63 in the second direction LY can be obtained. Further, an energy adjustment value can be derived in a reverse manner according to the energy of the laser light path GL after passing through the 1D physical characteristics element 332 and the third penetration rate T6.

Finally, based on the target laser focal position P63, the light modulator 150 is utilized to adjust the second laser focal position P62 to the target laser focal position P63. In some other embodiments, for all the laser focal positions within the circular range C7 obtained through rotation from the first laser focal position P61, the light adjustment can be achieved by performing the aforesaid step.

In summary, through the steps for providing at least two laser focal positions of the laser light path and the resulted arc path formed by the at least two laser focal positions in accordance with this disclosure, it can be determined whether or not the optical axis of the laser light path is oblique. Thus, real processing is not necessary to observe the focal position. In addition, based on the arc path and the coordinate values of the corresponding laser focal positions, the target laser focal position to satisfy the demand in light adjustment can be obtained.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An adjustment method of laser light path, comprising the steps of:
having a laser light path to penetrate through a measuring device to obtain at least two laser focal positions of the laser light path, the at least two laser focal positions forming an arc path;
applying a focal position-calculating device to calculate coordinate values of the at least two laser focal positions;
based on the arc path and the coordinate values of the at least two laser focal positions, applying the focal position-calculating device to calculate a target laser focal position; and
based on the target laser focal position, applying a light modulator to adjust each of the at least two laser focal positions to the target laser focal position.

2. The adjustment method of laser light path of claim 1, wherein the step of having the laser light path to penetrate through the measuring device to obtain the at least two laser focal positions of the laser light path includes the steps of:
applying the measuring device to obtain a first laser focal position of the laser light path;
rotating a rotating shaft;
applying the measuring device to obtain a second laser focal position of the laser light path; and
forming the arc path by the first laser focal position and the second laser focal position.

3. The adjustment method of laser light path of claim 2, wherein the step of rotating the rotating shaft includes the steps of:
applying the measuring device to determine whether or not an optical axis of a focusing lens is coincided with the first laser focal position; and
if the optical axis of the focusing lens is not coincided with the first laser focal position, then obtaining the second laser focal position by rotating the first laser focal position about the optical axis of the focusing lens.

4. The adjustment method of laser light path of claim 1, prior to the step of having the laser light path to penetrate through the measuring device to obtain the at least two laser focal positions of the laser light path, further including a step of generating the laser light path to the laser processing device.

5. An adjustment device of laser light path, comprising:
a laser processing device, configured for receiving a laser light path;
a measuring device, connected with the laser processing device, wherein the laser light path penetrates through the measuring device to form at least two laser focal positions, and the at least two laser focal positions form an arc path;
a focal position-calculating device, connected with the measuring device, wherein the focal position-calculating device calculates coordinate values of the at least two laser focal positions and further a target laser focal position; and
a light modulator, connected with the laser processing device and the focal position-calculating device, wherein, based on the target laser focal positions, the light modulator adjusts each of the at least two laser focal positions to the target laser focal position.

6. The adjustment device of laser light path of claim 5, further including a laser source for generating the laser light path to the laser processing device.

7. An adjustment method of laser light path, comprising the steps of:
having a laser light path to penetrate through a 2D measuring device to obtain a first laser focal position in a first direction and a first coordinate value in a second direction;
rotating the laser light path by an angle on the 2D measuring device from the first laser focal position to obtain a second laser focal position of the laser light path;
applying the 2D measuring device to obtain a second coordinate value of the second laser focal position in the first direction and the second direction;
based on the first coordinate value and the second coordinate value, applying a focal position-calculating device to calculate a target laser focal position; and
based on the target laser focal position, applying a light modulator to adjust each of the first laser focal position and the second laser focal position to the target laser focal position.

8. The adjustment method of laser light path of claim 7, wherein the step of having the laser light path to penetrate through the 2D measuring device to obtain the first laser focal position in the first direction and the first coordinate value in the second direction includes a step of adopting a beam profiler as the 2D measuring device.

9. The adjustment method of laser light path of claim 7, wherein the step of having the laser light path to penetrate through the 2D measuring device to obtain the first laser focal position in the first direction and the first coordinate value in the second direction includes a step of adopting a position-sensitive diode as the 2D measuring device.

10. The adjustment method of laser light path of claim 7, wherein the step of applying the focal position-calculating device to calculate the target laser focal position includes a step of forming the arch path according to the first laser focal position and the second laser focal position.

11. The adjustment method of laser light path of claim 7, prior to the step of having the laser light path to penetrate through the 2D measuring device to obtain the first laser focal position in the first direction and the first coordinate value in the second direction, further including a step of generating the laser light path to the laser processing device.

12. An adjustment device of laser light path, comprising:
a laser processing device, configured for receiving a laser light path;
a 2D measuring device, connected with the laser processing device, wherein the laser light path penetrates through the 2D measuring device to form at least two laser focal positions at a coordinate value in a first direction and a second direction, and the at least two laser focal positions form an arc path;
a focal position-calculating device, connected with the 2D measuring device, wherein the focal position-calculating device evaluates the coordinate value of the at least two laser focal positions in the first direction and the second direction to calculate a target laser focal position; and
a light modulator, connected with the laser processing device and the focal position-calculating device, wherein, based on the target laser focal position, the light modulator adjusts each of the at least two laser focal positions to the target laser focal position.

13. The adjustment device of laser light path of claim 12, wherein the 2D measuring device is a beam profiler.

14. The adjustment device of laser light path of claim 12, wherein the 2D measuring device is a position-sensitive diode.

15. The adjustment device of laser light path of claim 12, further including a laser source for generating the laser light path to the laser processing device.

16. An adjustment method of laser light path, comprising the steps of:
having a laser light path to penetrate through a 1D physical characteristics element in a 1D measuring device to obtain a first laser focal position corresponding to the laser light path, the 1D physical characteristics element having a given characteristics information;
applying an energy measuring element in the 1D measuring device to measure a first energy of the laser light path;
based on the given characteristics information and the first energy of the laser light path, applying a focal position-calculating device to calculate a first coordinate value of a first laser focal position;
having the first coordinate value as a starting point to rotate the laser light path by an angle to provide a second laser focal position and correspondingly a second energy on the 1D physical characteristics element;
based on the given characteristics information and the second energy of the laser light path, applying the focal position-calculating device to calculate a second coordinate value of a second laser focal position;
based on the first coordinate value and the second coordinate value, applying a focal position-calculating device to calculate a target laser focal position; and
based on the target laser focal position, applying a light modulator to adjust the first laser focal position and the second laser focal position to the target laser focal position.

17. The adjustment method of laser light path of claim 16, wherein the step of having the laser light path to penetrate through the 1D physical characteristics element in the 1D measuring device to obtain the first laser focal position corresponding to the laser light path includes a step of adopting an element having a plurality of different penetration rates in a 1D direction as the 1D physical characteristics element.

18. The adjustment method of laser light path of claim 16, wherein the step of having the laser light path to penetrate through the 1D physical characteristics element in the 1D measuring device to obtain the first laser focal position corresponding to the laser light path includes a step of adopting a physical characteristics curve changing information having a length-to-penetration rate match as the given characteristics information.

19. The adjustment method of laser light path of claim 18, wherein the step of applying the focal position-calculating device to calculate the first coordinate value of the first laser focal position includes the steps of:
based on the first energy of the first laser focal position to derive a first penetration rate after the laser light path penetrates through the 1D physical characteristics element; and
applying the 1D physical characteristics element to provide the physical characteristics curve changing information and the first penetration rate and to further obtain a first coordinate value of the first laser focal position.

20. The adjustment method of laser light path of claim 18, wherein the step of applying the focal position-calculating device to calculate the second coordinate value of the second laser focal position includes the steps of:
based on the second energy of the second laser focal position to derive a second penetration rate after the laser light path penetrates through the 1D physical characteristics element; and
applying the 1D physical characteristics element to provide the physical characteristics curve changing information and the second penetration rate and to further obtain a second coordinate value of the second laser focal position.

21. The adjustment method of laser light path of claim 16, wherein the step of applying the focal position-calculating device to calculate the target laser focal position includes the steps of:
based on the first laser focal position and the second laser focal position to form an arc path;
applying the focal position-calculating device to evaluate the first coordinate value of the first laser focal position, the second coordinate value of the second laser focal position, and the arc path to derive a third coordinate value of a center position of the arc path, and having the center position as the target laser focal position;
having the third coordinate value of the target laser focal position as a length of the target laser focal position;
applying the 1D physical characteristics element to provide the physical characteristics curve changing information and the length of the target laser focal position and to further obtain a third penetration rate of the target laser focal position; and
based on the second energy and the third penetration rate after the laser light penetrates through the 1D physical characteristics element to derive an energy adjustment value.

22. The adjustment method of laser light path of claim 16, wherein the 1D physical characteristics element has a plurality of different penetration rates in a first direction, the adjustment method further includes, after the step of applying the light modulator to adjust the first laser focal position and the second laser focal position to the target laser focal position, a step of rotating the 1D physical characteristics element by a 90° to switch a state that the 1D physical characteristics element has the plurality of different penetration rates in the first direction into another state that the 1D physical characteristics element has the plurality of different penetration rates in the second direction, and the first direction is different from the second direction.

23. The adjustment method of laser light path of claim 16, wherein the step of having the first coordinate value as the starting point to rotate the laser light path by the angle to provide the second laser focal position and correspondingly the second energy on the 1D physical characteristics element includes a step of applying the energy measuring element in the 1D measuring device to measure a second energy of the second laser focal position of the laser light path.

24. An adjustment device of laser light path, comprising:
a laser processing device, configured for receiving a laser light path;
a 1D measuring device, connected with the laser processing device, providing a given characteristics information, obtaining first energy of at least two laser focal positions formed by the laser light path to penetrate through the 1D measuring device;
a focal position-calculating device, connected with the 1D measuring device, wherein the focal position-calculating device evaluates the given characteristics information and the first energy of the at least two laser focal positions of the laser light path to calculate coordinate values of the at least two laser focal positions and to further calculate a target laser focal position according to the coordinate values of the at least two laser focal positions; and
a light modulator, connected with the laser processing device and the focal position-calculating device, wherein the light modulator adjusts each of the at least two laser focal positions to the target laser focal position.

25. The adjustment device of laser light path of claim 24, wherein the 1D measuring device includes a 1D physical characteristics element and an energy measuring element, the 1D physical characteristics element is disposed between the laser processing device and the energy measuring element, the 1D physical characteristics has a physical characteristics curve changing information furnished with the given characteristics information, and the energy measuring element is to measure the first energy of the laser light path while penetrating through the 1D physical characteristics element.

26. The adjustment device of laser light path of claim 25, wherein the 1D physical characteristics element has a plurality of different penetration rates in a 1D direction, and the physical characteristics curve changing information is in a length-to-penetration rate match.

27. The adjustment device of laser light path of claim 24, further including a laser source for generating the laser light path to the laser processing device.
